(19) United States
(12) Patent Application Publication
(10) Pub. No.: US 2009/0314059 A1
(43) Pub. Date: Dec. 24, 2009

(54) CERAMIC HEATER

(75) Inventor: Masanobu Yamauchi, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/124,813

(22) Filed: May 21, 2008

(30) Foreign Application Priority Data
May 22, 2007 (JP) 2007-135917

(51) Int. Cl. G01N 7/00; H05B 3/10

(52) U.S. Cl. 73/31.05; 219/552

(57) ABSTRACT

A ceramic heater is incorporated in a gas sensor capable of detecting the concentration of a specific gas contained in a target gas. The ceramic heater is composed of a heater base member made of ceramic, a heat generating member embedded in the heater base member, and electrode pads electrically connected to contact metal members. The contact metal members are electrically connected to external leads in the gas sensor. In the ceramic heater the electrode pads are formed on a contact area of the outer peripheral surface of the heater base member. The contact area includes a rear end part of the heater base member. On assembling the ceramic heater into the gas sensor, the contact metal members slid on the electrode pads formed in the contact area without directly contacting onto the outer peripheral surface of the heater base member.

### CROSS-REFERENCE TO RELATED APPLICATION

This application is related to and claims priority from Japanese Patent Application No. 2007-135917 filed on May 22, 2007, the contents of which are hereby incorporated by reference.

### BACKGROUND OF THE INVENTION

1. Field of the Invention

The present invention relates to a ceramic heater to be assembled into a gas sensor capable of detecting the concentration of a specific gas contained in a target gas.

2. Description of the Related Art

In general, a gas sensor is mounted to an exhaust gas system for an internal combustion engine of a mobile vehicle. The gas sensor has the capability of detecting the concentration of a specific gas such as oxygen and nitride oxide contained in an exhaust gas emitted from the internal combustion engine. For example, Japanese patent laid open publication No. JP 2001-147213 has disclosed such a gas sensor into which a sensor element and a ceramic heater are assembled. The ceramic heater is capable of heating the sensor element embedded in the gas sensor.

The ceramic heater is comprised of a heater base member made of ceramic, a heat generating member, and a pair of terminal leads. The heat generating member is embedded in the heater base member. The heat generating member is electrically connected to an outside power supply through the terminal leads. The pair of terminal leads is electrically connected to a pair of corresponding electrode pads. Those electrode pads are strongly connected to the pair of electrode pads by brazing on the outer peripheral surface of the pair of electrode pads formed on the outer peripheral surface of the heater base member.

There is a drawback, however, that the brazed connection part between the electrode pads and the terminal leads in the gas sensor are easily broken by corrosion.

FIG. 8 is an explanatory view of a conventional gas sensor after the assembly of a conventional ceramic heater is completed between contact metal members 92.

A conventional technique has proposed another electrical connection structure in a gas sensor in order to solve the conventional drawback described above.

In the electrical connection structure shown in FIG. 8, each electrode pad 911 is electrically connected to a corresponding external lead (omitted from FIG. 8) using a contact metal member 92.

The contact metal members 92 forcedly press on the surface of the electrode pads 911 toward the radial direction of the gas sensor.

FIG. 7A is an explanatory view of the conventional gas sensor before the conventional ceramic heater 9 is inserted and placed between contact metal members 92 in the gas sensor. FIG. 7B is an explanatory view of the conventional gas sensor during its assembling work in which the conventional ceramic heater 9 is gradually inserted between the contact metal members 92;

As shown in FIG. 7A and FIG. 7B, for example, in order to obtain an electrically-contacted state between the electrode pads 911 and the contact metal members 92, the ceramic heater 9 is inserted from its rear end part 901 between the pair of contact metal members 92 in the direction indicated by the arrow.

In FIG. 7B, the rear end part of the outer peripheral surface 900 of the heater base member 910 is contacted to the contact metal members 92. The heater base member 910 is made of ceramic.

As shown in FIG. 9A, there is a possibility that the outer peripheral surface 900 of the ceramic heater 9 and the contact metal member 92 are rubbed together, and as a result, abrasion 991 is generated on the outer peripheral surface of the contact metal member 92.

FIG. 9A is a side view of the contact metal member 92 in the conventional ceramic heater 9. FIG. 9B is an explanatory view of the rear end part of the conventional ceramic heater 9 where abrasion is generated or occurs. Further, as shown in FIG. 9B, there is a possibility of generating abrasion 992 on the surface of the electrode pad 911 by sliding it on the abrasion formed on the surface of the contact metal member 92.

As a result, there is a possibility of deteriorating the electrical contact condition between the electrode pads 911 formed on the heater base member 910 of the ceramic heater 9 and the contact metal members 92 in the gas sensor.

### SUMMARY OF THE INVENTION

It is an object of the present invention to provide a ceramic heater and a gas sensor with a superior electrical-contact capability between electrode pads and contact metal members.

To achieve the above purposes, the present invention provides a ceramic heater to be assembled into a gas sensor that is capable of detecting a concentration of a specific gas contained in a target gas. The gas sensor comprises contact metal members and external leads. The ceramic heater according to the present invention has a heater base member, a heat generating member, and electrode pads. The heater base member is made of ceramic, for example. The heat generating member is embedded in the heater base member. The electrode pads are electrically contacted to the contact metal members in the gas sensor into which the ceramic heater is assembled. The contact metal members are connected to the external leads in the gas sensor. In the ceramic heater, the electrode pads are formed on a contact area on the outer peripheral surface of the heater base member. In particular, this contact area includes a rear end part (or a rear side edge part) of the heater base member. In other words, this contact area is extended to the rear end part (or to the rear side edge part) of the heater base member. Still further, on assembling the ceramic heater according to the present invention into the gas sensor, each contact metal member slides on the corresponding electrode pad formed on this contact area on the outer peripheral surface of the heater base member. Each contact metal member is electrically contacted to the corresponding electrode pad formed on the outer peripheral surface of the heater base member in the ceramic heater after completion of the assembling work.

In the ceramic heater according to the present invention, because the electrode pads are formed in the above contact area of the outer peripheral surface of the heater base member, and each electrode pad includes and is extended to the rear end part (or the rear side edge part) of the heater base member, there is no exposed surface of the heater base member in this contact area.

The structure of the ceramic heater according to the present invention enables that the contact metal members are sliding on the electrode pads without contacting any outer peripheral surface of the heater base member during the assembling work of the gas sensor. This structure can protect the surface of the contact metal members from contacting to the outer peripheral surface of the heater base member made of ceramic, and as a result, can avoid forming any abrasion on the contact metal members.

Still further, this structure of the ceramic heater can also avoid contacting the electrode pads onto the contact metal members with abrasion because there is no abrasion on the surface of each contact metal member. This can avoid forming any abrasion on the electrode pads of the ceramic heater.

As a result, it is possible to contact the electrode pads onto the contact metal members under the most electrically-appropriate surface condition. The present invention provides the gas sensor with a high reliability in electrical-contact condition between the contact metal members and the electrode pads of the ceramic heater.

### BRIEF DESCRIPTION OF THE DRAWINGS

A preferred, non-limiting embodiment of the present invention will be described by way of example with reference to the accompanying drawings, in which:

FIG. 1 is a sectional view of a gas sensor having a ceramic heater according to a first embodiment of the present invention;

FIG. 2A is an explanatory view of a rear end side of the ceramic heater according to the first embodiment shown in FIG. 1;

FIG. 2B is an explanatory view of the rear end side which intersects the rear end side at right angles, as shown in FIG. 2A;

FIG. 2C is a top view of the ceramic heater according to the first embodiment shown in FIG. 1;

FIG. 3A is an explanatory view of the rear end side of the ceramic heater according to a second embodiment of the present invention;

FIG. 3B is an explanatory view of the rear end side which intersects the rear end side at right angles, as shown in FIG. 3A;

FIG. 3C is a top view of the ceramic heater according to the second embodiment;

FIG. 4A is an explanatory view of the rear end side of the ceramic heater according to a modification of the second embodiment in which the electrode pads are extended to a tapered part;

FIG. 4B is an explanatory view of the rear end side which intersects the rear end side at right angles, as shown in FIG. 4A;

FIG. 5A is an explanatory view of the rear end side of the ceramic heater according to a third embodiment of the present invention;

FIG. 5B is an explanatory view of the rear end side which intersects the rear end side at right angles, as shown in FIG. 5A;

FIG. 5C is a top view of the ceramic heater according to the second embodiment;

FIG. 6A is an explanatory view of the rear end side of the ceramic heater according to a modification of the third embodiment in which the electrode pads are extended to a round part according to the third embodiment;

FIG. 6B is an explanatory view of the rear end side which intersects the rear end side at right angles, as shown in FIG. 6A;

FIG. 7A is an explanatory view of a conventional gas sensor before a conventional ceramic heater is assembled between contact metal members;

FIG. 7B is an explanatory view of the conventional gas sensor in assembling work in which the conventional ceramic heater is inserted between the contact metal members;

FIG. 8 is an explanatory view of the conventional gas sensor after completion of assembling the conventional ceramic heater between contact metal members in the gas sensor;

FIG. 9A is a side view of the contact metal member with abrasion in the conventional gas sensor;

FIG. 9B is an explanatory view of the rear end part of the conventional ceramic heater with abrasion; and

FIG. 10 is an explanatory view of a rear end side of the ceramic heater according to another modification according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

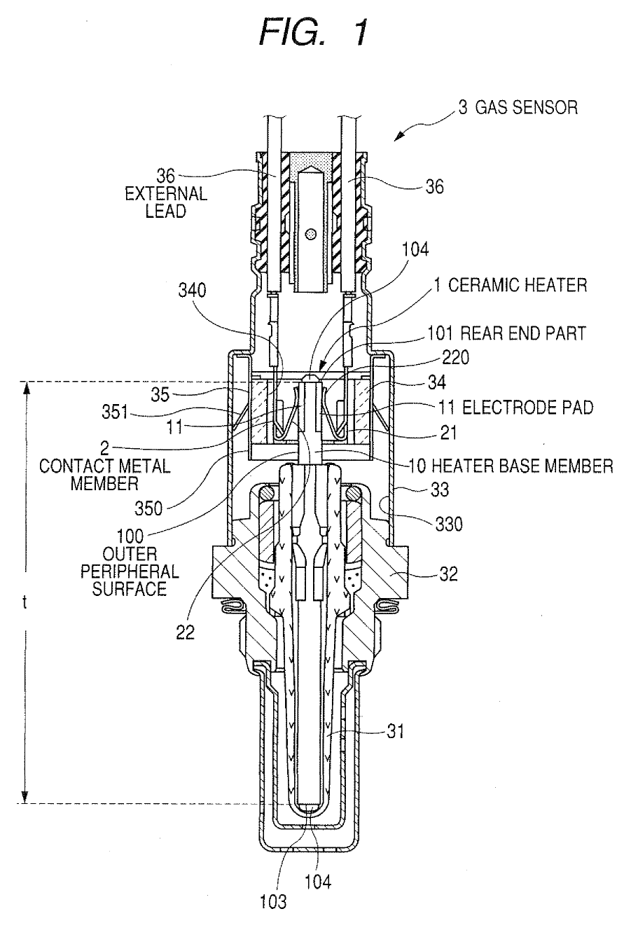

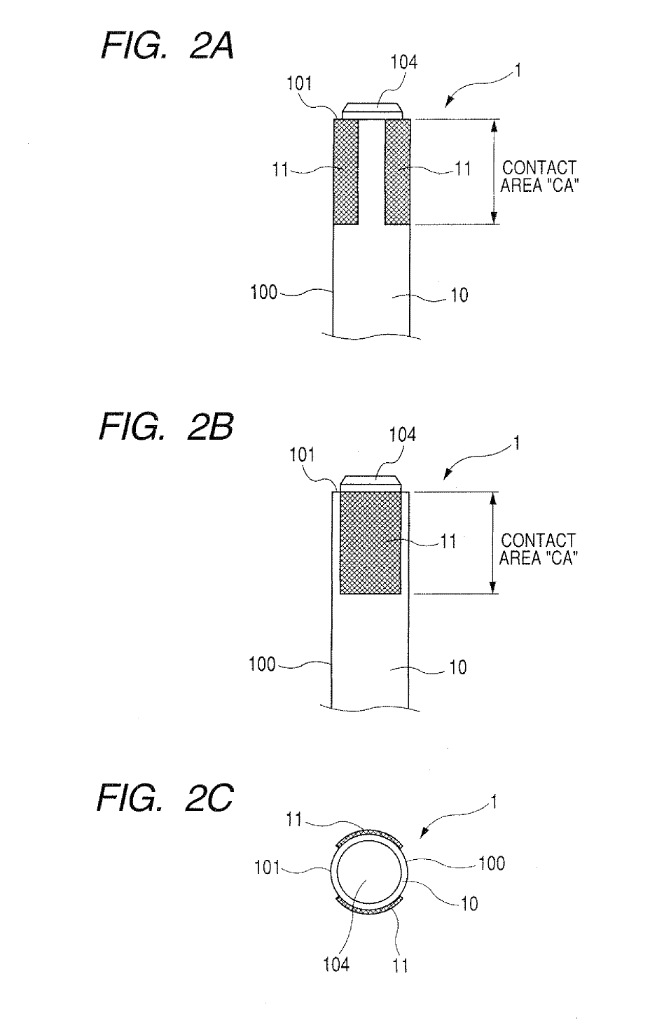

A description will be given of the ceramic heater according to a first embodiment of the present invention with reference to FIG. 1A and FIGS. 2A to 2C.

FIG. 1 is a sectional view of a gas sensor incorporating a ceramic heater according to the first embodiment. FIG. 2A is an explanatory view of the rear end side of the ceramic heater 1 according to the first embodiment shown in FIG. 1. FIG. 2B is an explanatory view of the rear end side which intersects the rear end side at right angles, as shown in FIG. 2A. FIG. 2C is a top view of the ceramic heater 1 according to the first embodiment. As shown in FIG. 1, the ceramic heater 1 is assembled into the gas sensor 3. The gas sensor 3 is capable of detecting a concentration of a specific gas contained in a target gas, for example, such as an exhaust gas emitted from internal combustion engines of motor vehicles.

As shown in FIG. 1 and FIG. 2A, the ceramic heater 1 is comprised of a heater base member 10 made of ceramic, a heat generating member (not shown) embedded in the heater base member 10, and a pair of electrode pads 11. The pair of the electrode pads 11 is forcedly pressed by a pair of contact metal members 2. The pair of the contact metal members 2 is electrically connected to the pair of external leads 36. The pair of the electrode pads 11 includes a rear end part 101 (or a rear side edge 101) of the heater base member 10. The electrode pads 11 are formed in the contact area “CA” (see FIG. 2A and FIG. 2B) on the outer peripheral surface 100 of the heater base member 10.

As shown in FIG. 1, the gas sensor 3 has a cup-shaped sensor element 31, a hollow housing 32, and an atmosphere-side cover 33 connected to the rear end part of the hollow housing 32. The ceramic heater 1 is inserted in and supported by the cup-shaped sensor element 31. The cup-shaped sensor element 31 is inserted in and supported by the hollow housing 32.

As also shown in FIG. 1, an atmosphere-side insulating glass 34 is placed between the ceramic heater 1 and the atmosphere-side cover 33. The atmosphere-side insulating glass 34 covers the rear end part of the ceramic heater 1. The atmosphere-side insulating glass 34 is supported by a cylindrical holder 35. The cylindrical holder 35 has outside springs 351 at the outer peripheral surface 350 thereof. The outer springs 351 forcedly press the inside surface 330 of the atmosphere-side cover 33 toward the outside of the diameter direction of the gas sensor 3. That is, the cylindrical holder 35 contacts to the inside surface 330 of the atmosphere-side cover 33 through the outside springs 351. The atmosphere-side insulating glass 34 is fixed to and supported by a predetermined position in the gas sensor 3 by expanding and contracting the outside springs 351

As shown in FIG. 1, the pair of the contact metal members 2 is placed between the inside surface 340 of the atmosphere-side insulating glass 34 and the ceramic heater 1.

Each contact metal member 2 has a base plate part 21 and a contact part 22. The base plate part 21 contacts to the inside surface 340 of the atmosphere-side insulating glass 34. The contact part 22 of each contact metal member 2 is formed by bending the contact metal member 2, and contacts to the corresponding electrode pad 11 of the ceramic heater 1. A bent part 220 as the front part of the contact part 22 is slightly bent. The bent part 220 formed in the contact part 22 forcedly presses the corresponding electrode pad 11. The rear end side of the ceramic heater 1 is supported by the pair of the contact metal members 2.

As shown in FIG. 2C, the cross section of the ceramic heater 1 of the first embodiment in a direction perpendicular to the axis of the ceramic heater 1 is approximately a circular shape. That is, the ceramic heater 1 is approximately a cylindrical-shaped heater.

A projecting part 104 is formed at each of the front end part 103 and the rear end part 101 in the ceramic heater 1. The projecting part 104 has a smaller diameter than that of another part in the ceramic heater 1.

The part, other than the projecting part 104 having the smaller diameter, designated by the reference character “t” shown in FIG. 1 has such a cylindrical shape. The outer peripheral surface of the part in the diameter direction designated by the reference character “t” is the outer peripheral surface 100. In other words, the outer peripheral surface 100 does not contain the surface of the projecting part 104.

Next, a description will now be given of the action and effects of the ceramic heater 1 according to the first embodiment of the present invention.

The electrode pad 11 reaches and includes, namely, is extended to the rear end part 101 (or the rear side edge part 101) on the outer peripheral surface 100 of the heater base member 10.

The outer peripheral surface 100 in the contact area “CA” (see FIG. 2A and FIG. 2B) which is in the rear end side on the outer peripheral surface of the heater base member 10, is covered with the electrode pads 11.

There is no exposed area of the outer peripheral surface 100 corresponding to the formation area for the electrode pads 11 in the contact area “CA”, as shown in FIG. 2A and FIG. 2B.

This structure of the ceramic heater 1 according to the first embodiment enables that the contact metal members 2 are sliding onto the electrode pad 11 without contacting any outer peripheral surface 100 during assembling work of the ceramic heater 1 into the gas sensor 3.

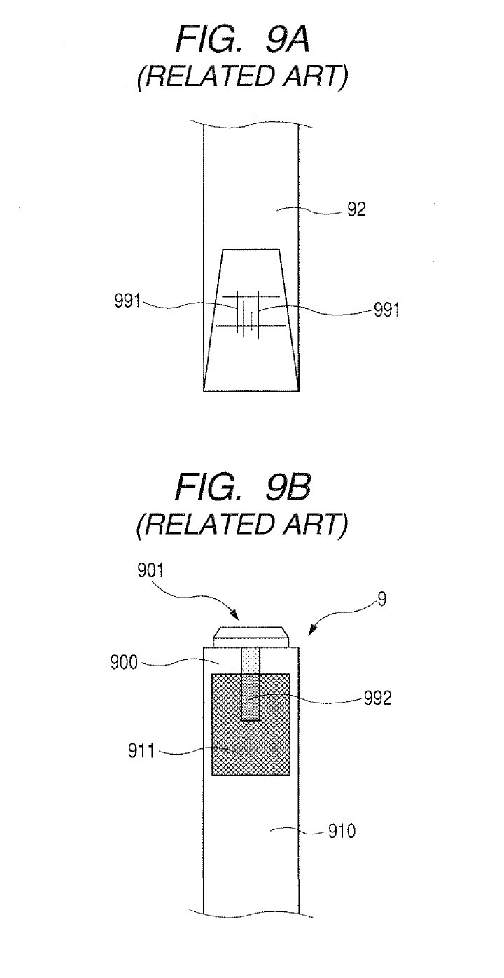

This can avoid any occurrence of generating abrasion on the contact metal members 2. For example, such abrasion is designated by the reference character 991 in the conventional case shown in FIG. 9A.

Further, there is no possibility of generating abrasion on the surface of the electrode pad 11. The abrasion is designated by the reference character 992 in the conventional case shown in FIG. 9B.

According to the first embodiment of the present invention, it is possible to assemble the electrode pads 11 of the ceramic heater 1 into the contact metal members 2 in the gas sensor 3 without occurrence of any abrasion thereon. As a result, the present invention can provide the gas sensor 3 with a superior reliability in electrical contact condition between the electrode pads 11 and the contact metal members 2.

Still further, because the cross section of the ceramic heater 1 in the direction perpendicular to the axis of the ceramic heater 1 has approximately a circular shape, it is possible to efficiently provide the action and effects of the structure of the ceramic heater 1. That is, the approximate circular-shaped cross section of the ceramic heater 1 according to the first embodiment easily provides a small contact area between the electrode pad 11 and the contact metal member 2. In this case, the surface condition of the electrode pads 11 and the contact metal members 2 becomes an important matter of determining the electrical contact condition between the electrode pad 11 and the contact metal member 2.

On applying the structure of the ceramic heater described above to various ceramic heaters having an approximately circular-shaped cross section, it is possible to avoid occurrence of abrasion generated on the surface of the electrode pads and the surface of the contact metal members. This can efficiently increase the reliability in electrical contact condition between the electrode pads and the contact metal members in the gas sensor as well as the ceramic heater

As described above, the first embodiment of the present invention can provide the gas sensor having the ceramic heater having the above structure with a superior reliability in electrical contact state between the electrode pads and the contact metal members.

### Second Embodiment

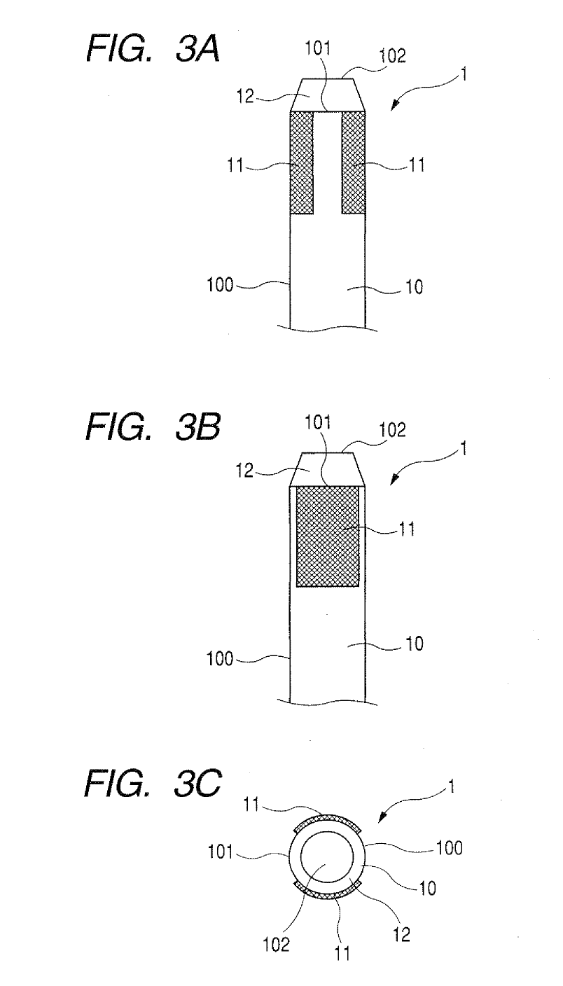

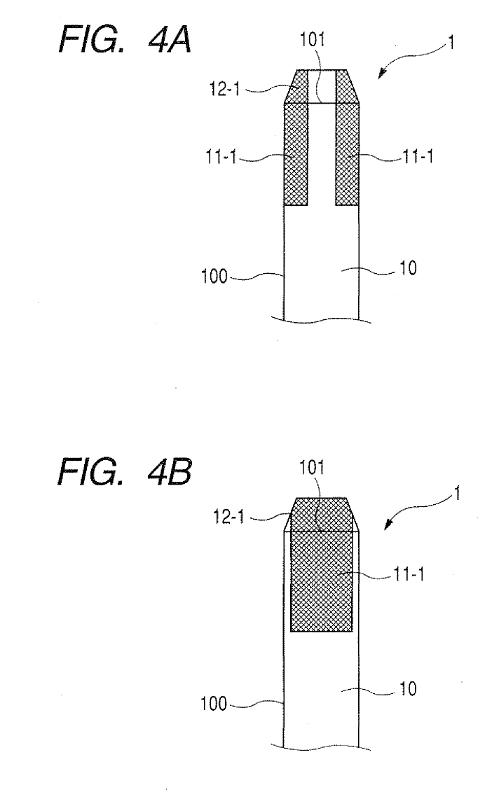

A description will be given of the ceramic heater according to a second embodiment of the present invention with reference to FIG. 3A, FIG. 3B, FIG. 3C, FIG. 4A and FIG. 4B.

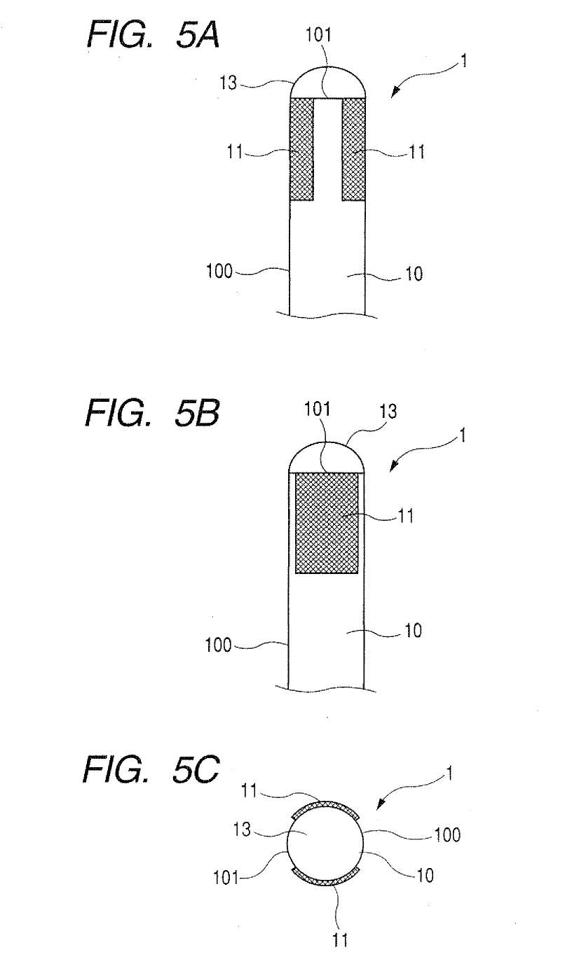

FIG. 3A is an explanatory view of the rear end side of the ceramic heater 1 according to the second embodiment. FIG. 5B is an explanatory view of the rear end side which intersects the rear end side at right angles, as shown in FIG. 3A. FIG. 3C is a top view of the ceramic heater 1 according to the second embodiment.

As shown in FIG. 3A to FIG. 5C, the ceramic heater 1 according to the second embodiment has a tapered part 12. The tapered part 12 acts as the projection part formed on the rear end part 101 (or the rear side edge part 101) on the outer peripheral surface 100 of the ceramic heater 1. The diameter of the tapered part 12 is gradually decreased toward a flat-shaped end surface 102.

Like the first embodiment, the cross section of the ceramic heater 1 of the second embodiment in the direction perpendicular to the axis of the ceramic heater 1 has approximately the circular shape,

In the structure of the ceramic heater 1 according to the second embodiment, although the flat-shaped end surface 102 is formed at the end side of the tapered part 12, it is possible to eliminate the flat-shaped end surface 102 and only form the tapered part 12 on the rear end part 101 of the outer peripheral surface 100 of the heater base member 19 in the ceramic heater 1 shown in FIG. 3A to FIG. 3C.

Other components of the ceramic heater according to the second embodiment are the same as those of ceramic heater according to the first embodiment. The explanation for the same components are omitted here.

The structure of the ceramic heater according to the second embodiment enables easy assembly of the electrode pads 11 and the contact metal members 2. Other actions and effects of the ceramic heater according to the second embodiment are the same as those of the first embodiment.

### Modification

FIG. 4A is an explanatory view of the rear end side of the ceramic heater in which the electrode pads 11-1 are extended to the tapered part 12-1 according to an modification of the second embodiment. FIG. 4B is an explanatory view of the rear end side which intersects the rear end side at right angles, as shown in FIG. 4A.

As shown in FIG. 4A and FIG. 4B, the electrode pads 11-1 are extended onto the tapered part 12-1. This structure shown in FIG. 4A and FIG. 4B protects the contact metal members 2 (omitted from FIG. 4A and FIG. 4B) from contacting to the outer peripheral surface of the heater base member 10 in the tapered part 12-1.

That is, on assembling the electrode pads 11-1 into the corresponding contact metal members 2, each contact metal member 2 is firstly contacted to the tapered part 12-1. Because each electrode pad 11-1 is extended onto the taper pad 12-1, it is possible to avoid abrasion from occurring on the contact metal members 2 (omitted from FIG. 4A and FIG. 4B). As a result, the structure shown in the second embodiment according to the present invention provides the ceramic heater 1 with superior reliability in electrical contact state between the electrode pads 11-1 and the contact metal members 2.

### Third Embodiment

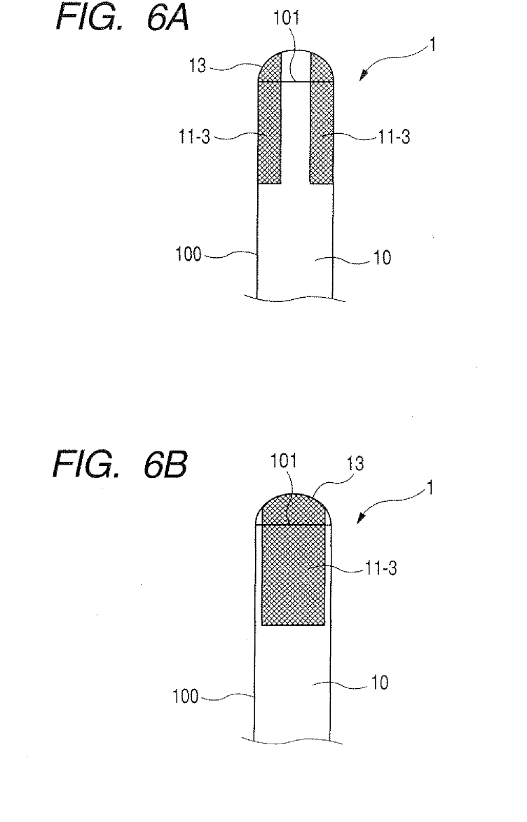

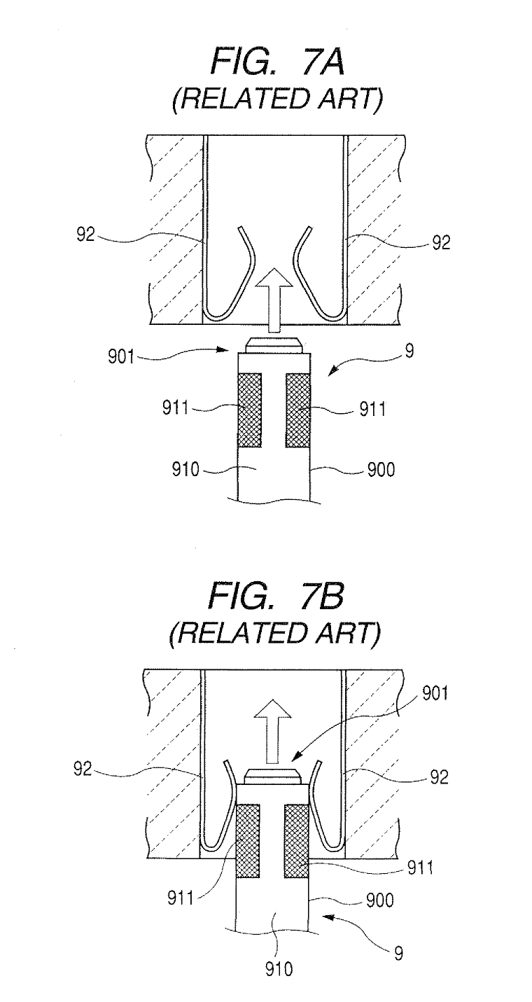

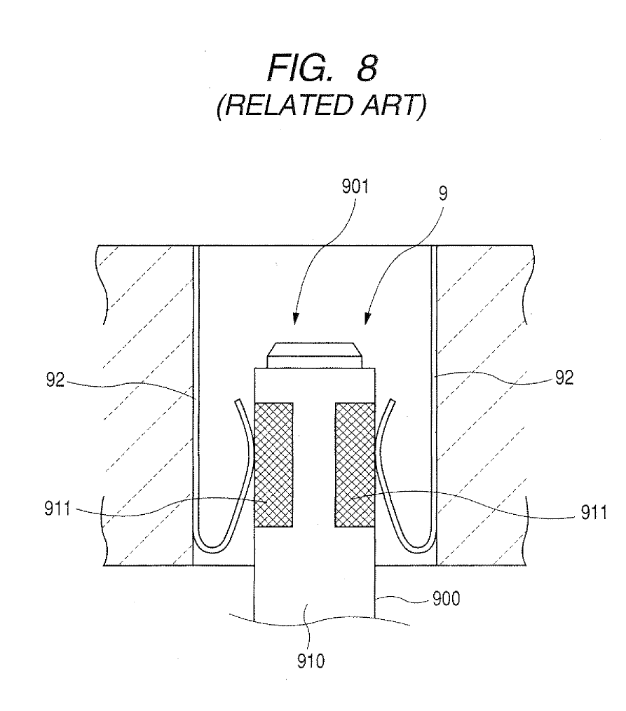

A description will be given of the ceramic heater according to a third embodiment of the present invention with reference to FIG. 5A, FIG. 5B, FIG. 5C, FIG. 6A and FIG. 6B.

FIG. 5A is an explanatory view of the rear end side of the ceramic heater according to the third embodiment. FIG. 5B is an explanatory view of the rear end side which intersects the rear end side at right angles, as shown in FIG. 5A. FIG. 5C is a top view of the ceramic heater according to the second embodiment.

As shown in FIG. 5A to FIG. 5C, a curved surface part 13 is formed as the projection part on the rear end part 101 of the outer peripheral surface 100 of the heater base member 10 in the ceramic heater 1. An axial cross section of the curved surface part 13 in its axial direction has a curved shape.

In the third embodiment, the curved surface part 13 has a hemispherical shape. The radius of curvature of the curved surface takes various values.

The cross section of the ceramic heater 1 in a direction perpendicular to the axis of the ceramic heater 1 has approximately the circular shape.

Other components of the ceramic heater according to the third embodiment are the same as those of the ceramic heater according to the first embodiment. The explanation for the same components is omitted here.

The structure of the ceramic heater according to the third embodiment enables easy assembly of the electrode pads 11 and the contact metal members 2. Other action and effects of the structure of the ceramic heater according to the third embodiment are same of those of the first embodiment.

### Modification

FIG. 6A is an explanatory view of the rear end side of the ceramic heater according to a modification of the third embodiment in which the electrode pads are extended to a round part according to the third embodiment. FIG. 6B is an explanatory view of the rear end side which intersects the rear end side at right angles, as shown in FIG. 6A;

As shown in FIG. 6A and FIG. 6B, it is possible that the electrode pad 11-3 is extended onto the curved surface part 13. This structure shown in FIG. 6A and FIG. 6B protects the heater base member 10 and the contact metal members 2 (omitted from FIG. 6A and FIG. 6B) from generating abrasion at the curved surface part 13.

That is, on assembling the electrode pads 11-3 into the contact metal members 2 (omitted from FIG. 6A and FIG. 6B), each contact metal member 2 is firstly contacted to the curved surface part 13 in the ceramic heater 1. Because the electrode pad 11-3 is extended onto the curved surface part 13, it is possible to avoid generating abrasion on the contact metal members 2 by contacting to the outer surface of the heater base member 10 at the curved surface part. As a result, the structure according to the third embodiment provides the ceramic heater 1 with a superior reliability in electrical contact state between the electrode pads 11 and the contact metal members 2.

### Other Features and Effects

The ceramic heater according to the present invention can be applied to various types of gas sensors such as an air-fuel ratio (A/F) sensor, an oxygen (O₂) sensor, and a nitrogen oxide (NOx) sensor. The ceramic heater is inserted and placed in the inside of the cylindrical shaped sensor element having a bottom part, for example. It is also possible to assemble the ceramic heater according to the present invention and a sensor element with on body. The ceramic heater is made of alumina (Al₂O₃), for example.

Through the description as well as claims according to the present invention, it is described that the front end part of the gas sensor is inserted into an exhaust gas pipe. The front end part of the gas sensor detects a concentration of a specific gas contained in a target gas such as an exhaust gas which flows in the exhaust gas pipe. The opposite part to the front end part in the gas sensor is the rear end part side.

Through the description as well as claims according to the present invention, the outer peripheral surface of the ceramic heater is a surface of the ceramic heater 1 designated by the reference character “t” shown in FIG. 1.

In the ceramic heater as another aspect of the present invention, it is desirable that the cross section of the ceramic heater in its axial direction is approximately a circular shape. This structure can efficiently provide the action and effects of the present invention. That is, the ceramic heater having an approximately circular-shaped cross section makes it possible to have a decreased contact area between the electrode pads and the contact metal members. This means that the contacted-surface condition between the electrode pads and the contact metal members becomes an important matter for determining the contact condition. On applying the concept of the present invention to the ceramic heater having approximately a circular-shaped cross section, it becomes possible to protect the surface of the electrode pads and the surface of the contact metal members from generating abrasion. This makes it possible to efficiently increase the reliability in contact between the electrode pads and the contact metal members.

In the ceramic heater as another aspect of the present invention, it is desirable that a tapered part is formed on the rear end side of the heater base member, and the diameter of the tapered part is gradually decreased toward the front end surface of the tapered part. This structure makes it possible to easily and smoothly perform assembling work for the electrode pads and the contact metal members.

In the ceramic heater as another aspect of the present invention, it is desirable that each electrode pad is extended onto the tapered part. This structure having the tapered part makes it possible to protect the contact metal members from contacting to the outer surface of the heater base member made of ceramic. That is, on assembling the electrode pads into the contact metal members of the gas sensor, the contact metal members firstly slide on the tapered part. Because the electrode pads are extended to the tapered pad, namely, the electrode pads are further formed on the tapered part, it is possible to avoid sliding the contact metal members on the outer surface of the heater base member in the tapered part, and thereby to protect the contact metal members from generating abrasion. This can provide the ceramic heater with a superior reliability in electrical contact state between the electrode pads and the contact metal members.

In the ceramic heater as another aspect of the present invention, it is desirable that a curved part is formed on the rear end part of the heater base member. A cross section of the curved part in its axial direction is a curved shape. This structure makes it possible to smoothly assemble the electrode pads into the contact metal members of the gas sensor.

In the ceramic heater as another aspect of the present invention, it is desirable that each electrode pad is extended onto the curved part. This structure makes it possible to protect the contact metal members from generating abrasion, which is generated if the contact metal members are contacted to the outer surface of the heater base member at the curved part.

That is, on assembling the electrode pads in the ceramic heater into the contact metal members of the gas sensor, the contact metal members in the gas sensor are firstly contacted to the curved part of the ceramic heater. Because the electrode pads are further formed onto the curved part, therefore, this structure of the electrode pads makes it possible to protect the contact metal members from generating abrasion, which is generated if the contact metal members are contacted to the outer surface of the heater base member at the curved part. Accordingly this can provide the ceramic heater with a superior reliability in electrical contact state between the electrode pads and the contact metal members.

In the ceramic heater 1 according to the present invention, because the electrode pads 11 are formed within the contact area “CA” (for example, shown in FIG. 2A and FIG. 2B) of the outer peripheral surface 100 of the heater base member 10, and each electrode pad 11 is extended to the rear end part 101 (or the rear side edge part 101) of the heater base member 10, there is no exposed part of the outer peripheral surface of the heater base member 10 in this contact area “CA”. This contact area “CA” shown in FIG. 2A and FIG. 2B is formed on at least a part of the outer peripheral surface 100 of the heater base member 10, as shown in FIG. 2A and FIG. 2B.

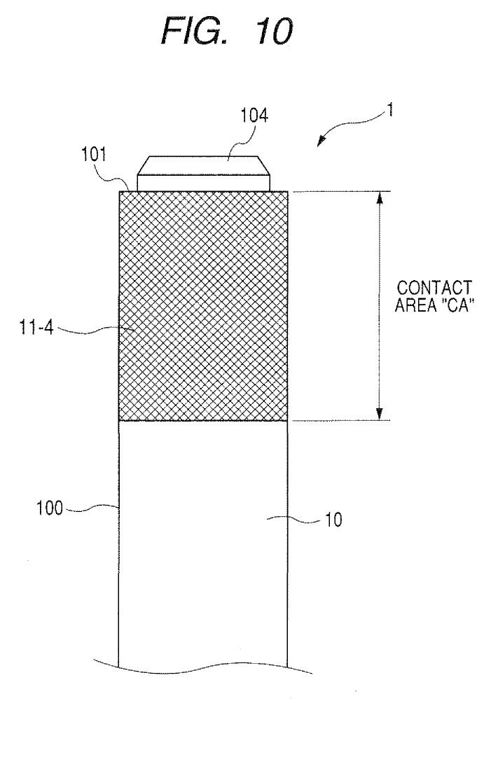

However, the present invention is not limited by this structure. For example, it is possible to form the electrode pads 11 on the entire of the contact area “CA”, as shown in FIG. 10. Further, this structure can avoid contacting the surface of the contact metal members 2 onto the outer peripheral surface 100 of the heater base member 10 made of ceramic, and as a result, can avoid forming any abrasion on the contact metal members 2 when assembling the ceramic heater into the gas sensor.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A ceramic heater to be assembled into a gas sensor having contact metal members and external leads, the gas sensor detecting a concentration of a specific gas contained in a target gas, the ceramic heater comprising:
a heater base member made of ceramic;
a heat generating member embedded in the heater base member; and
electrode pads electrically connected to the contact metal members connected to the external leads,
wherein the electrode pads are formed on an area including a rear end part on an outer peripheral surface of the heater base member.

2. The ceramic heater according to claim 1, wherein a cross section of the ceramic heater in its axial direction is approximately a circular shape.

3. The ceramic heater according to claim 1, wherein a tapered part is formed on the rear end part of the heater base member and a diameter of the tapered part is gradually decreased toward the front of the tapered part.

4. The ceramic heater according to claim 1, wherein a tapered part is formed on the rear end part of the heater base member and a diameter of the tapered part is gradually decreased toward the front of the tapered part.

5. The ceramic heater according to claim 3, wherein each electrode pad is so formed that it is extended onto a tip of the tapered part.

6. The ceramic heater according to claim 4, wherein each electrode pad is so formed that it is extended onto a tip of the tapered part.

7. The ceramic heater according to claim 1, wherein a curved part is formed on the rear end part of the heater base member and a cross section of the curved part in its axial direction is a curve.

8. The ceramic heater according to claim 2, wherein a curved part is formed on the rear end part of the heater base member and a cross section of the curved part in its axial direction is a curve.

9. The ceramic heater according to claim 7, wherein each electrode pad is so formed that it is extended onto the curved part.

10. The ceramic heater according to claim 8, wherein each electrode pad is so formed that it is extended onto the curved part.

11. A gas sensor comprising:
external leads;
contact metal members connected to the external leads; and
a ceramic heater comprising:
a heater base member made of ceramic;
a heat generating member embedded in the heater base member; and
electrode pads electrically connected to the contact metal members,
wherein the electrode pads are formed on an area including a rear end part of an outer peripheral surface of the heater base member.

12. The gas sensor according to claim 11, wherein a tapered part is formed on the rear end part of the heater base member and a diameter of the tapered part is gradually decreased toward the front of the tapered part.

13. The gas sensor according to claim 12, wherein each electrode pad is so formed that it is extended onto the tapered part.

14. The gas sensor according to claim 11, wherein a curved part is formed on the rear end part of the heater base member and a cross section of the curved part in its axial direction is a curve.

15. The gas sensor according to claim 14, wherein each electrode pad is so formed that it is extended onto the curved part.
